(19) United States
(12) Patent Application Publication
(10) Pub. No.: US 2014/0311516 A1
(43) Pub. Date: Oct. 23, 2014

(54) SYSTEM AND METHOD FOR PERSONAL ADHESIVE PROMOTIONAL DISPLAY

(71) Applicant: 101122918 Saskatchewan, Ltd, Regina (CA)

(72) Inventors: Frank E. McInally, Regina (CA); Darrin Oremba, Regina (CA); Cliff Mapes, Regina (CA)

(73) Assignee: 101122918 Saskatchewan, Ltd, Regina (CA)

(21) Appl. No.: 14/258,447

(22) Filed: Apr. 22, 2014

Related U.S. Application Data
(60) Provisional application No. 61/879,374, filed on Sep. 18, 2013.

(30) Foreign Application Priority Data
Apr. 22, 2013 (CA) 2813821

(51) Int. Cl. G09F 19/00; A41G 5/00

(52) U.S. Cl. CPC G09F 19/00; A41G 5/008
USPC 132/201; 132/53

(57) ABSTRACT

A method of advertising comprising the use of adhesive stickers for releasable adhesive attachment to the face of a user. The sticker is in the shape of a facial hair growth. Different types of promotional or advertising messages could be printed on the sticker. An advertising method, using printed stickers in the general format of facial hair such as moustaches or the like, is also disclosed.

### CROSS REFERENCE TO RELATED APPLICATIONS

This application claims priority to U.S. Provisional Patent Application Serial No.: 61/879,374, filed on Sep. 18, 2013, and also claims priority to Canadian Patent Application Serial No.: 2,813,821, filed on Apr. 22, 2013, the entireties of which are incorporated by reference herein.

### FIELD OF THE INVENTION

The present invention relates to promotional items for promoting activities, campaigns, events and like occurrences, campaigns or organizations, and more specifically to adhesive items such as labels or stickers to be affixed to the person.

### BACKGROUND OF THE INVENTION

It is known in the field of promotional activities and marketing to advertise, promote or publicize a target organization, event, fundraising campaign or other group or event by means of items that can be distributed to the public, thereby spreading public awareness. For example, leaflets or brochures are commonly distributed to publicize and raise awareness of a target such as a sporting event or business service.

One such product which can typically be produced at a low cost allowing for wide distribution and usage and promotion of events and the like are stickers or labels. Everything from promotional imprinted nametags and bumper stickers through too many other different types of stickers or labels have been produced in the past. What is needed is a form of promotional material that is inherently visible and formed in such a way that a recipient might be more inclined to use it and therefore enhance the potential marketing impact.

A consumable product which could be used in large quantities at large crowd events and which would have an element of fun to their use would encourage maximum adoption or use of the product. Printing of labels or stickers that have a general element of fun to their overall shape her appearance would maximize the likelihood of their use. Promotional or advertising media could then be printed onto those labels are stickers as well, for the purpose of promoting the event at which they would be distributed, or for the purpose of promoting sponsors, vendors or any other thing.

There are many different manufacturers of label substrate and adhesive material, which allow for the development or use of labels or stickers that are capable of releasable adhesive attachment to many different types of surfaces. Dependent upon the adhesion qualities of the adhesive used on a particular label it may be removable and repositionable, or alternatively it might be a one-time usage product which once it was attached once was not reusable. Using a little substrate that was to a degree repositionable or reusable would be ideal for these types of products as are contemplated for use on human skin surfaces, since it would be possible than to reposition them into a correct position.

Overall then, if it was possible to provide a skin attachable adhesive label or the like which had an overall fun appearance and also carried advertising material thereon, it is believed that this would be positively received in the marketing industry.

### SUMMARY OF THE INVENTION

The present invention therefore seeks to provide a wearable advertising display system, which in some embodiments comprises an adhesive sticker suitable for adherence to the face of a recipient. Specifically, the adhesive sticker would be shaped in the form of facial hair such as a moustache in one of any number of forms.

According to a first aspect of the present invention, then, there is provided an adhesive sticker for adherence to the face of a person, the adhesive sticker configured to represent facial hair. The adhesive sticker preferably comprises a visual indicator indicating a promotional target.

According to a second aspect of the present invention, there is a provided a method for promoting a promotional target comprising the use of a temporary sticker for application to a user's face, the sticker configured to represent facial hair.

In exemplary embodiments of the present invention, the sticker could represent one of numerous moustache types or other common facial hair elements. The adhesive, which must be effective to retain the sticker in place on the skin for a desired period of time, is preferably selected from available hypoallergenic adhesives so as to reduce the risk of undesirable skin reactions when the sticker is applied to the skin. The sticker could be made using medical tape or other hypoallergenic adhesive material wherein the visual indicator could be applied directly to the non-stick surface of the material. The visual indicator may comprise a colour or colours and/or logo indicative of the promotional target, such as for example the primary identifying colours of a sports team where the team is the promotional target. The sticker may be die-cut or otherwise capable of release from the backing material, and multiple stickers may be provided on a single sheet with each being die-cut or otherwise capable of release from the backing material.

A detailed description of an exemplary embodiment of the present invention is given in the following. It is to be understood, however, that the invention is not to be construed as being limited to this embodiment.

There is thus provided a wearable advertising display system for presentation of promotional content, the system comprising: a wearable display, the wearable display comprising: a front surface; the front surface configured to receive a promotional content display; a back surface; the back surface configured to be releasably affixed to a wearer by a user compatible adhesive; wherein the wearable advertising display system is configured to simulate a shape of a facial hair growth.

In some embodiments, the promotional content is formed directly on the front surface. In some embodiments, the promotional content is formed on a separate member that can be releasably attached to the front surface. In some embodiments, the separate member is attached to the front surface by one of an adhesive or a magnet.

In some embodiments, the display system and separate member are provided in the form of a user configurable kit.

In some embodiments, the system is provided in the form of a peelable sticker on a card, wherein the card includes additional promotional content

There is also provided a method of displaying promotional content on a wearable advertising display system, comprising: providing a wearable display, the wearable display comprising: a front surface; the front surface configured to receive a promotional content display; a back surface; the back surface configured to be releasably affixed to a wearer by a user compatible adhesive; wherein the wearable advertising display system is configured to simulate a shape of a facial hair growth; affixing the wearable display to the face in a position comparable to a typical position of the facial hair growth being simulated.

In some embodiments of the method, the promotional content is formed directly on the front surface. In some embodiments the method further comprises forming the promotional content on a separate member that can be releasably attached to the front surface. In some embodiments the method further comprises attaching the separate member to the front surface by one of an adhesive or a magnet.

In some embodiments the method further comprises providing the display system and separate member in the form of a user configurable kit.

In some embodiments the method further comprises providing the system in the form of a peelable sticker on a card, wherein a user peels the sticker from the card prior to use, wherein the card includes additional promotional content

Accordingly, the present disclosure provides apparatus and methods for making and using a wearable advertising display system configured to simulate a form of facial hair growth.

### BRIEF DESCRIPTION OF THE DRAWINGS

In the accompanying drawings, which illustrate an exemplary embodiment of the present invention:

FIG. 1A is a view of a card bearing a one-piece adhesive moustache item, shown as die-cut to enable peeling of the sticker from the backing material;

FIG. 1B is a view of a card bearing a two-piece adhesive moustache item;

FIG. 1C is a view of a card bearing a large one-piece adhesive moustache item;

FIG. 2 is a view of a card bearing multiple adhesive moustache items; and

FIG. 3 is a detailed side view of an adhesive moustache item on backing.

An exemplary embodiment of the present invention will now be described with reference to the accompanying drawings.

### DETAILED DESCRIPTION OF EXEMPLARY EMBODIMENTS

Turning now to the drawings, exemplary promotional adhesive items comprising a wearable advertising display system are illustrated. It will be understood that the examples are illustrative only and non-limiting in terms of the scope of the present invention. Moustache forms of adhesive facial hair are shown, but other forms of facial hair, for example sideburns, are within the scope of the present invention.

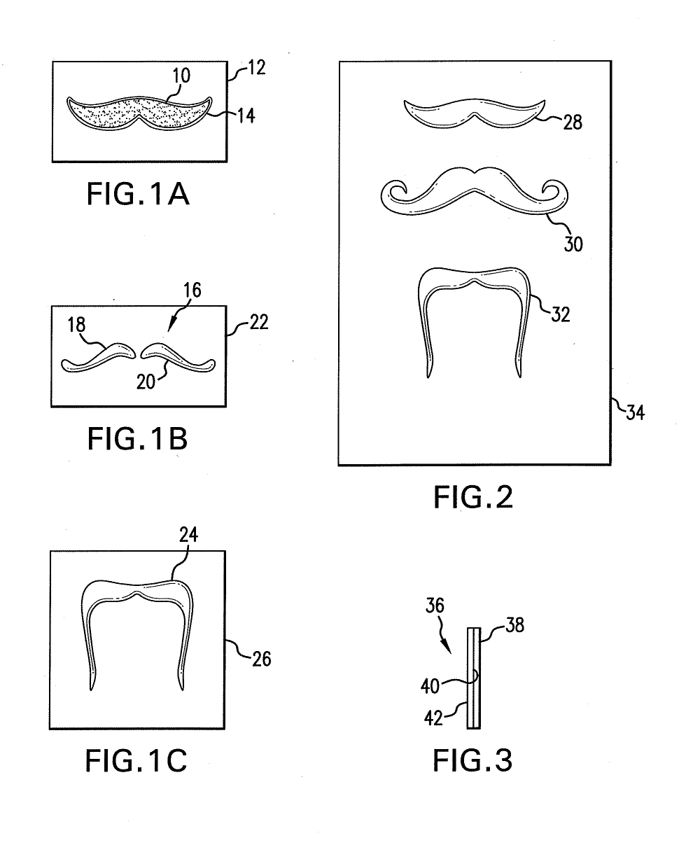

In FIG. 1A, a wearable advertising display system comprising an adhesive-backed moustache sticker 10 is shown. The sticker 10 is in the form of a common moustache type, and it is bordered by a die-cut edge 14 in a manner well known to those skilled in the art for release from the card 12. In use, the card 12 would be distributed to the public, and the user would peel the sticker 10 off of the card 12 and apply the sticker 10 to their face between the upper lip and nose. The card could then be discarded or could alternatively present information relating to the promotional target for retention by the user.

While sticker 10 presents a one-piece adhesive moustache design, FIG. 1B illustrates a two-piece design of the wearable advertising display system. The two-piece sticker 16 comprises a first piece 18 and a second piece 20, which are again retained on a card 22 until use, and although not shown they can also be provided with die-cut edging for ease of removal from the card 22. Alternatively, stickers according to the present invention can be configured to be cut from a backing material using scissors or the like, but it is preferable to use die-cutting.

FIG. 1C shows a card 26 bearing a larger moustache adhesive sticker 24, illustrating that different sizes and configurations of stickers and supporting cards are within the scope of the present invention.

FIG. 2 shows a card 34 bearing multiple adhesive stickers 28, 30, 32, providing alternative sticker designs on a single card for selection by a user or multiple users.

FIG. 3 illustrates a detailed side view of an adhesive moustache sticker 36 on a backing material 38. The sticker 36 comprises two opposed sides, an adhesive side 40 for adherence to the backing material 38 and a visible side 42. The adhesive side 40 is preferably provided with a hypoallergenic adhesive coating, which will avoid adverse skin reactions when the sticker 36 is applied to the user's skin. To use the sticker 36, the user would peel the sticker 36 away from the backing material 38, and then position the sticker 36 in a desired location on the user's face, specifically between the upper lip and nose where a moustache would normally grow on a person. The user would then press the adhesive side against their skin to adhere the sticker 36 to the skin, thereby retaining the sticker 36 in place.

The Figures generally illustrate embodiments where an adhesive-backed layer is applied to a receiving backing material such as a card that can be distributed to the public, and die-cut moustache stickers are peeled off of the backing material. It is also within the scope of the present invention to make the stickers in other forms and with other materials, as long as the adhesive functionality is present. For example, medical tape could be used and a moustache design applied to the non-adhesive side of the tape, with the advantage that the adhesive coating is known for hypoallergenic properties. Other forms of adhesive arrangements are well known to those skilled in the art.

The visible side 42 of the sticker 36 would preferably be provided with a visual indicator indicative of the promotional target. For example, where it is desired to promote a sporting event, the team colours might be applied to the sticker 36, such that the user would display a promotional moustache sticker with team-specific colours. Various indicia are possible within the scope of the invention, including for example colours and logos.

In some embodiments, the wearable advertising system could be produced such that the promotional content is printed on the visible side 42 of the display. In other embodiments, it may be desirable to provide a display as a generic mount, onto which a separate member that includes the promotional content is affixed. In these examples, the separate member might be attached to the visible side 42 of the display by a reversible adhesive, by a permanent adhesive, or by complimentary magnets, one on the display member and one on the surface of the visible side 42 of the display, having sufficient force to maintain the promotional content member in register with the remainder of the display system. In these embodiments, the separate member will be preferably shaped to conform substantially to the shape of the remainder of the display in order to maintain the illusion of a moustache or whatever other facial hair growth is being simulated by the wearable display.

It might also be desired to use the present invention without a particular visual indicator. For example, it is known to hold so-called “Movember” events for raising funds and public awareness regarding prostate cancer and men's mental health initiatives, and in such a case the application of a simple moustache sticker without additional visual indicators might meet the desired promotional goals.

As will be clear from the above, the present invention not only provides a promotional item that would be visible during use, thereby helping to meet the promotional goals, but it would also be seen as enjoyable by a user and accordingly be more likely to be worn. Rather than a brochure or bumper sticker that may be more likely to be stored or disposed of, the adhesive stickers according to the present invention will be appealing and fun to wear and display.

In embodiments where the promotional content is provided on a separate member that can be releasably attached, the system might be provided as a user configurable kit, where the user could have blank members printed with promotional content, and then assemble the finished display prior to use or sale. In these embodiments, where the promotional content is provided on a separate member, and advantage is provided in that the cost of using the system is reduced since the basic sticker can be ordered in bulk and then the separate member configured for particular content. Thus, an economy of scale is realized in that basic stickers can be ordered in bulk, and then configured as needed with each new promotional campaign as the user desires.

The foregoing is considered as illustrative only of the principles of the invention. The scope of the claims should not be limited by the exemplary embodiment set forth in the foregoing, but should be given the broadest interpretation consistent with the specification as a whole.

What is claimed:

1. A wearable advertising display system for presentation of promotional content, the system comprising a wearable display having:
a. a front surface configured to receive a promotional content display; and
b. a back surface configured to be releasably affixed to a wearer by a user compatible adhesive;
wherein the wearable advertising display system is configured to simulate a shape of a facial hair growth.

2. The wearable advertising display system of claim 1, wherein the promotional content is formed directly on the front surface.

3. The wearable advertising display system of claim 1, wherein the promotional content is placed on a separate member that can be releasably attached to the front surface.

4. The wearable advertising display system of claim 3, wherein the separate member is attached to the front surface by one of a magnet or an adhesive.

5. The wearable advertising display system of claim 3, wherein the display system and separate member are provided in the form of a user configurable kit.

6. The wearable advertising display system of claim 1, wherein the system is provided in the form of a peelable sticker on a card, wherein the card includes additional promotional content.

7. A method of displaying promotional content using a wearable advertising display system, said method comprising the steps of:
a. providing a wearable display comprising:
i. a front surface configured to receive a promotional content display; and
ii. a back surface configured to be releasably affixed to a wearer by a user compatible adhesive;
wherein the wearable advertising display system is configured to simulate a shape of a facial hair growth; and
b. affixing the wearable display to the face of a person in a position comparable to a typical position of the facial hair growth being simulated.

8. The method of claim 7, wherein the promotional content is formed directly on the front surface.

9. The method of claim 7, further comprising forming the promotional content on a separate member that can be releasably attached to the front surface.

10. The method of claim 9, further comprising attaching the separate member to the front surface by one of an adhesive or a magnet.

11. The method of claim 9, further comprising providing the display system and separate member in the form of a user configurable kit.

12. The method of claim 7, further comprising providing the system in the form of a peelable sticker on a card, wherein a user peels the sticker from the card prior to use, wherein the card includes additional promotional content.
